(19) United States
(12) Patent Application Publication
(10) Pub. No.: US 2018/0139444 A1
(43) Pub. Date: May 17, 2018

(54) Method and Apparatus of Video Coding Using Flexible Quadtree and Binary Tree Block Partitions

(71) Applicant: MEDIATEK INC., Hsin-Chu (TW)

(72) Inventors: Han HUANG, San Jose, CA (US); Shan LIU, San Jose, CA (US)

(21) Appl. No.: 15/812,160

(22) Filed: Nov. 14, 2017

Related U.S. Application Data
(60) Provisional application No. 62/422,623, filed on Nov. 16, 2016.

(51) Int. Cl. H04N 19/119; H04N 19/176; H04N 19/196; H04N 19/159; H04N 19/122

(52) U.S. Cl. CPC H04N 19/119; H04N 19/176; H04N 19/122; H04N 19/159; H04N 19/196

(57) ABSTRACT

A method and apparatus for video coding using flexible quadtree and binary tree block partition are disclosed. According to this method, a current block is partitioned into multiple final sub-blocks using one or more stages of quadtree partitioning and binary tree partitioning, where at least one sub-block is generated by applying the quadtree partitioning to one previous sub-block generated by the binary tree partitioning. According to another method, one or more horizontal splitting flags and one or more vertical splitting flags are used for determining block partition of the current block into multiple sub-blocks using one or more stages of quadtree partitioning and binary tree partitioning. Multiple sub-blocks partitioned from the current block are determined according to the horizontal splitting flags and the vertical splitting flags. The multiple sub-blocks are then encoded or decoded.

### CROSS REFERENCE TO RELATED APPLICATIONS

The present invention claims priority to U.S. Provisional Patent Application, Ser. No. 62/422,623, filed on Nov. 16, 2016. The U.S. Provisional Patent Application is hereby incorporated by reference in its entirety.

### FIELD OF THE INVENTION

The present invention relates to block partition for video coding. In particular, the present invention discloses video coding methods using flexible quadtree and binary tree block partitions.

### BACKGROUND AND RELATED ART

The High Efficiency Video Coding (HEVC) standard is developed under the joint video project of the ITU-T Video Coding Experts Group (VCEG) and the ISO/IEC Moving Picture Experts Group (MPEG) standardization organizations, and is especially with partnership known as the Joint Collaborative Team on Video Coding (JCT-VC). In HEVC, one slice is partitioned into multiple coding tree units (CTU). In main profile, the minimum and the maximum sizes of CTU are specified by the syntax elements in the sequence parameter set (SPS). The allowed CTU size can be 8×8, 16×16, 32×32, or 64×64. For each slice, the CTUs within the slice are processed according to a raster scan order.

The CTU is further partitioned into multiple coding units (CU) to adapt to various local characteristics. A CTU can be further partitioned into multiple Coding Units (CUs) through Quad-Tree or Quadtree (QT) partitioning. As shown in FIG. 1, the QT partition splits a block of size 4N×4N into 4 equal-size 2N×2N sub-blocks. The CTU can be a single CU (i.e., no splitting) or can be split into four smaller units of equal size, which correspond to the nodes of the coding tree. If units are leaf nodes of the coding tree, the units become CUs. Otherwise, the quadtree splitting process can be iterated until the size for a node reaches a minimum allowed CU size as specified in the SPS (Sequence Parameter Set).

According to HEVC, each CU can be partitioned into one or more prediction units (PU). Coupled with the CU, the PU works as a basic representative block for sharing the prediction information. Inside each PU, the same prediction process is applied and the relevant information is transmitted to the decoder on a PU basis. A CU can be split into one, two or four PUs according to the PU splitting type. HEVC defines eight shapes for splitting a CU into PU, including 2N×2N, 2N×N, N×2N, N×N, 2N×nU, 2N×nD, nL×2N and nR×2N partition types. Unlike the CU, the PU may only be split once according to HEVC.

After obtaining the residual block by the prediction process based on PU splitting type, the prediction residues of a CU can be partitioned into transform units (TU) according to another quadtree structure which is analogous to the coding tree for the CU. The TU is a basic representative block having residual or transform coefficients for applying the integer transform and quantization. For each TU, one integer transform having the same size as the TU is applied to obtain residual coefficients. These coefficients are transmitted to the decoder after quantization on a TU basis.

A more flexible CU structure, named as Quad-Tree-Binary-Tree or Quadtree-plus-Binary-Tree (QTBT) (H. Huang, et al., “EE2.1: Quadtree plus binary tree structure integration with JEM tools,” JVET-00024, May 2016, Geneva, Switzerland) shows better coding performance compared to the QT structure in HEVC. In QTBT, as shown in FIG. 1, a CTU is firstly partitioned by a QT structure. The QT leaf nodes are further partitioned by a binary-tree (BT) structure. There are two splitting types (i.e., the symmetric horizontal splitting and symmetric vertical splitting) in the binary-tree splitting. FIG. 2 illustrates examples of binary tree splitting including horizontal BT partition 210 splitting a 4N×4N block into two sub-blocks (i.e., a top sub-block and a bottom sub-block) of size 4N×2N and vertical BT partition 220 splitting a 4N×4N block into two sub-blocks (i.e., a left sub-block and a right sub-block) of size 2N×4N. FIG. 2 also illustrates one example of 2-level binary tree partition 230 by applying horizontal BT partition first and then applying vertical BT partition to the lower 4N×2N sub-block, and another example of 2-level binary tree partition 240 by applying vertical BT partition first and then applying horizontal BT partition to the left 2N×4N sub-block.

In JVET-D0117 (X. Li, et al., “Multi-Type-Tree”, JVET-D0117, October 2016, Chengdu, CN), a triple-tree (TT) partition is proposed to further improve the coding performance. A TT partition can be horizontal or vertical, as shown in FIG. 3. In horizontal TT partition 310, a 4N×4N block is split into 3 blocks of sizes 4N×N, 4N×2N, and 4N×N, respectively. In vertical TT partition 320, a 4N×4N block is split into 3 blocks of sizes N×4N, 2N×4N and N×4N, respectively.

FIG. 4 illustrates an example of QTBT block partitioning 410 and its corresponding QTBT structure 420. The solid lines indicate quadtree splitting and dotted lines indicate binary tree splitting. In each splitting node (i.e., non-leaf node) of the binary tree, one flag is used to indicate which splitting type (i.e., horizontal or vertical) is used, 0 may indicate horizontal splitting and 1 may indicate vertical splitting.

While the QTBT block partition offers flexibility to allow more possible partitions than the conventional QT or BT, the QTBT partition process is still limited. In particular, in the QTBT partition process, the QT is always applied to an initial block to partition the initial block into sub-blocks. The BT is then applied to the sub-blocks generated by the QT block partition. In order to achieve performance improvement over the QTBT block partition, more flexible block partition is disclosed in the present invention.

### BRIEF SUMMARY OF THE INVENTION

A method and apparatus for video coding using flexible quadtree and binary tree block partition are disclosed. According to the present invention, the current block is partitioned into multiple final sub-blocks using one or more stages of quadtree partitioning and binary tree partitioning, where when quadtree partitioning is applied to a first target block, the first target block is partitioned into four sub-blocks by the quadtree partitioning, when binary tree partitioning is applied to a second target block, the second target block is partitioned into two sub-blocks by the binary tree partitioning, and at least one sub-block is generated by applying the quadtree partitioning to one previous sub-block generated by the binary tree partitioning. The multiple final sub-blocks are then encoded to generate compressed bits to include in a video bitstream or the multiple final sub-blocks are decoded from the video bitstream.

The current block may correspond to a coding tree unit (CTU) and each final sub-block may correspond to a coding unit (CU), prediction unit (PU) or transform unit (TU). In another example, the current block corresponds to a coding tree unit (CTU), each CTU is partitioned using one or more stages of quadtree partitioning into one or more leaf nodes, said one or more leaf nodes are further partitioned using one or more stages of binary tree partitioning into two or more BT-partition sub-blocks, and at least one of said two or more BT-partition sub-blocks is further partitioned by the quadtree partitioning into four sub-blocks.

According to another method of video coding, one or more horizontal splitting flags and one or more vertical splitting flags are signaled in a video bitstream to indicate block partition of the current block into multiple sub-blocks using one or more stages of quadtree partitioning and binary tree partitioning at an encoder side, or said one or more horizontal splitting flags and said one or more vertical splitting flags are parsed from the video bitstream to determine block partition of the current block into said multiple sub-blocks using one or more stages of quadtree partitioning and binary tree partitioning at a decoder side. Multiple sub-blocks partitioned from the current block are determined according to said one or more horizontal splitting flags and one or more vertical splitting flags. The multiple sub-blocks are encoded to generate compressed bits to include in a video bitstream or the multiple sub-blocks are from the video bitstream.

If one target block is partitioned into four sub-blocks using quadtree partitioning, one horizontal splitting flag and one vertical splitting flag associated with the target block indicate horizontal binary partition and vertical binary partition. If one target block is partitioned into one top sub-block and one bottom sub-block using binary tree partitioning, one horizontal splitting flag associated with the target block indicates horizontal binary partition and one vertical splitting flag associated with the target block indicates no vertical binary partition. If one target block is partitioned into one left sub-block and one right sub-block using binary tree partitioning, one vertical splitting flag associated with the target block indicates vertical binary partition and one horizontal splitting flag associated with the target block indicates no horizontal binary partition. If one target block is not partitioned at all, one horizontal splitting flag and one vertical splitting flag associated with the target block indicate no horizontal binary partition and no vertical binary partition.

If one horizontal splitting flag associated with a target block is not present in the video bitstream, said one horizontal splitting flag associated with the target block is inferred to have a value indicating horizontal binary partition if height of the target block is greater than a minimum block height; and said one horizontal splitting flag associated with the target block is inferred to have a value indicating no horizontal binary partition if height of the target block is smaller than or equal to the minimum block height. If one vertical splitting flag associated with a target block is not present in the video bitstream, said one vertical splitting flag associated with the target block is inferred to have a value indicating vertical binary partition if width of the target block is greater than a minimum block width; and said one vertical splitting flag associated with the target block is inferred to have a value indicating no vertical binary partition if width of the target block is smaller than or equal to the minimum block width.

The horizontal splitting flags and vertical splitting flags can be bypass coded or adaptive binary coded with one or more sets of contexts. The horizontal splitting flags and e vertical splitting flags can share a same set of contexts or use two separate sets of contexts. In one embodiment, a first separate set of contexts for the horizontal splitting flags is dependent on a respective horizontal splitting flag of an immediate previous coded block and a second separate set of contexts for the vertical splitting flags is dependent on a respective vertical splitting flag of the immediate previous coded block. In another embodiment, a first separate set of contexts for the horizontal splitting flags is dependent on respective horizontal splitting flags of an above neighboring block and a left neighboring block, and a second separate set of contexts for the vertical splitting flags is dependent on respective vertical splitting flags of the above neighboring block and the left neighboring block. In yet another embodiment, a first separate set of contexts for the horizontal splitting flags is dependent on a vertical depth of a left neighboring block and a second separate set of contexts for the vertical splitting flags is dependent on a horizontal depth of the left neighboring block. In still yet another embodiment, a first separate set of contexts for the horizontal splitting flags is dependent on vertical depths of an above neighboring block and a left neighboring block, and a second separate set of contexts for the vertical splitting flags is dependent on horizontal depths of the above neighboring block and the left neighboring block.

### BRIEF DESCRIPTION OF THE DRAWINGS

FIG. 1 illustrates an example of splitting a block of size 4N×4N into 4 equal-size 2N×2N sub-blocks using quadtree partition.

FIG. 2 illustrates examples of binary tree (BT) splitting including horizontal BT partition, vertical BT partition, 2-level BT partition by applying horizontal BT partition first and then applying vertical BT partition to the lower sub-block, and another 2-level BT partition by applying vertical BT partition first and then applying horizontal BT partition to the left sub-block.

FIG. 3 illustrates examples of triple-tree (TT) partition including a horizontal TT partition and a vertical TT partition.

FIG. 4 illustrates an example of quadtree and binary tree (QTBT) block partitioning and its corresponding QTBT structure.

FIG. 5 illustrates an example of Flexible quadtree and binary tree (FQTBT) according to the present invention by applying further QT to the QTBT partition in FIG. 4.

FIG. 6 illustrates examples of using a horizontal split flag and a vertical split flag to indicate no partition, horizontal binary partition, vertical binary partition and quadtree partition.

FIG. 7 illustrates a flowchart of an exemplary coding system using flexible quadtree and binary tree partitions, where a quadtree partition is further applied to a previous binary tree partitioned block.

FIG. 8 illustrates a flowchart of another exemplary coding system using block partition, where a horizontal split flag and a vertical split flag are used to signal flexible quadtree and binary tree partitions.

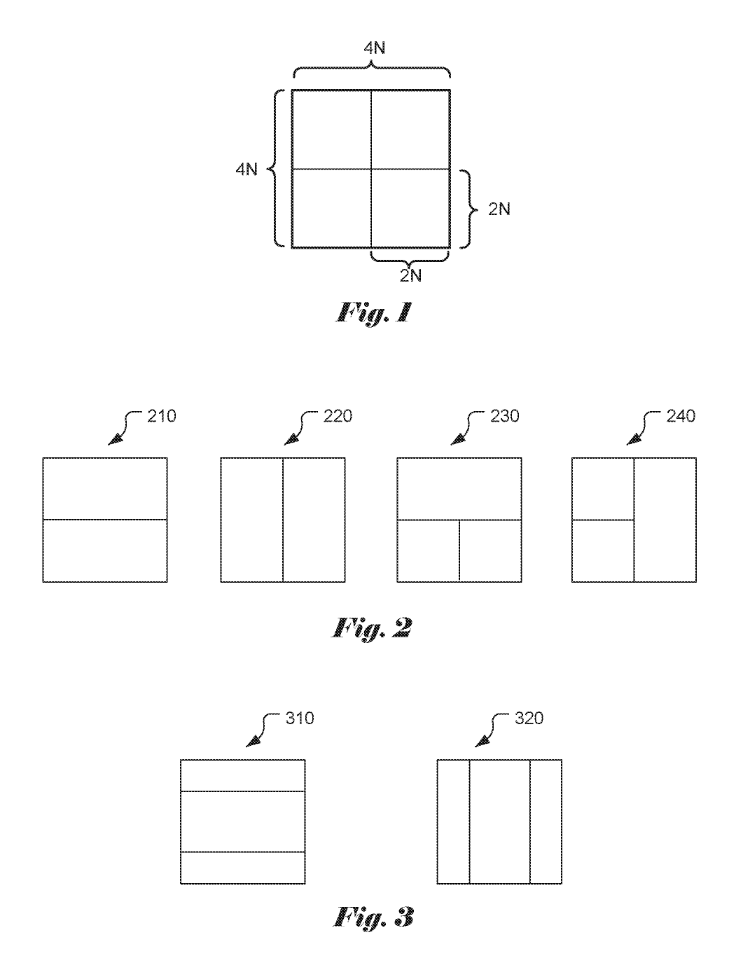

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

According to the existing video encoder or decoder using the quadtree and binary tree (QTBT) structure for block partition, the QT is always applied to an initial block to partition the initial block into sub-blocks. The BT is then applied to the sub-blocks generated by the QT. The QT split in HEVC can be regarded as simultaneously horizontal and vertical splits. In other words, the split of a block is indicated by only one flag to indicate split or not in both direction. If the split flag is true, the block is split in both the horizontal and vertical directions, resulting in four sub-blocks. Otherwise, the block is not split (i.e., neither in the horizontal direction nor vertical direction). The BT split in QTBT can be regarded as split in only one direction at a time. Also, BT is applied to the leaf nodes of QT. After the BT split process is finished, the QTBT block partition results in final sub-blocks. For any BT-split node, the QT split is not allowed.

In the present invention, the horizontal split and vertical split are separately indicated by two flags: hor_split_flag and ver_split_flag. Each flag can be determined to be “0” or “1” independently from the other, where “0” means not split and “1” means split.

Flexible QT and BT Structure

In order to improve coding performance, flexible block partition using QT and BT is disclosed. According to this method, QT and BT partitions are used to split a block into multiple final sub-blocks by allowing QT splitting be applied to a sub-block of BT splitting. In other words, QT and BT can be applied interchangeable so that a QT-split sub-block can be further partitioned using BT partition and a BT-split sub-block can be further partitioned using QT partition. This new block partition method is referred Flexible QT and BT (FQTBT) in this disclosure.

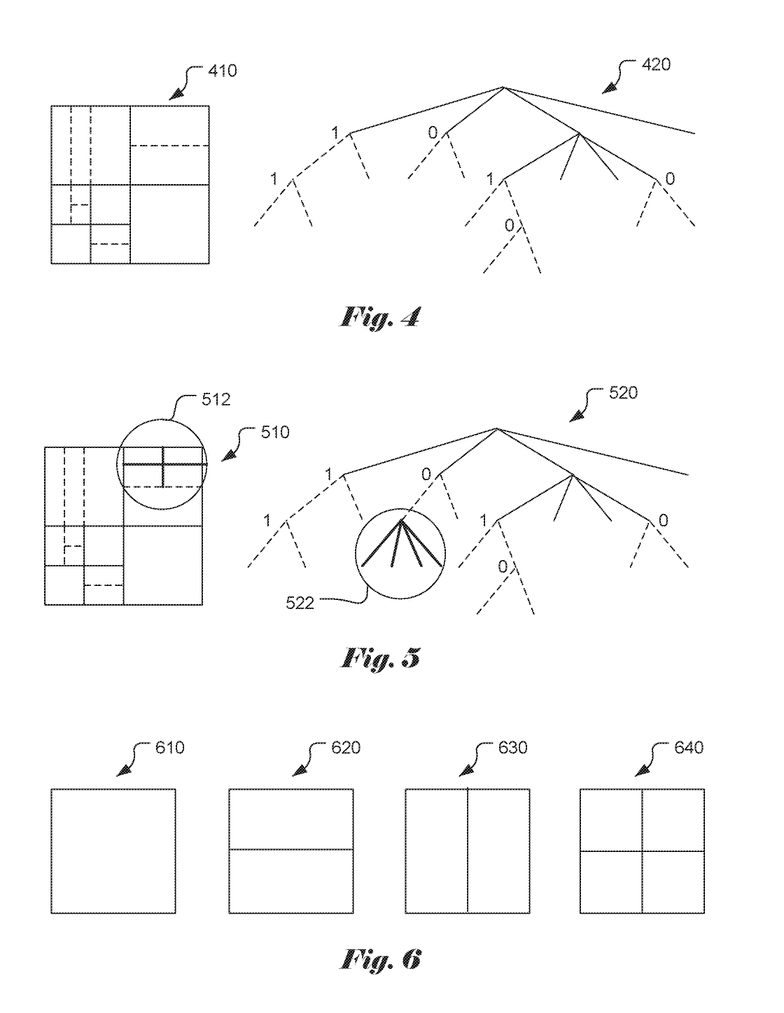

FIG. 5 illustrates an example of Flexible QT and BT (FQTBT) according to the present invention, where FQTBT block partition 510 is shown and additional QT partition is further applied to a sub-block resulted from the conventional QTBT partition of FIG. 4. In this example, the QTBT partitioned sub-block at the upper-right corner of the original block is further partitioned by a QT 512. The corresponding FQTBT structure 520 is also shown in FIG. 5, where the four newly partitioned sub-blocks 522 are shown.

In one embodiment, the split flag is signaled separately for the horizontal and vertical directions. An example of syntax table of FQTBT is shown in Table 1.

TABLE 1

| coding_tree( x0, y0, log2CbWidth, ctDepthHor, log2CbHeight, ctDepthVer ) { | Note |
|---|---|
| if( y0 + ( 1 << log2CbHeight ) <= pic_height_in_luma_samples && | |
| log2CbHeight > MinCbLog2SizeY ) | |
| hor_split_flag[ x0 ][ y0 ] | (1-1) |
| if( x0 + ( 1 << log2CbWidth ) <= pic_width_in_luma_samples && | |
| log2CbWidth > MinCbLog2SizeY ) | |
| ver_split_flag[ x0 ][ y0 ] | (1-2) |
| if( hor_split_flag[ x0 ][ y0 ] && ver_split_flag[x0][y0] ) { | (1-3a) |
| x1 = x0 + ( 1 << ( log2CbWidth − 1 ) ) | (1-3b) |
| y1 = y0 + ( 1 <<( log2CbHeight − 1 ) ) | |
| coding_tree( x0, y0, log2CbWidth − 1, ctDepthHor + 1, log2CbHeight−1, ctDepthVer+1 ) | |
| if( x1 < pic_width_in_luma_samples ) | |
| coding_tree( x1, y0, log2CbWidth − 1, ctDepthHor + 1, log2CbHeight−1, ctDepthVer+1 ) | |
| if( y1 < pic_height_in_luma_samples ) | |
| coding_tree( x0, y1, log2CbWidth − 1, ctDepthHor + 1, log2CbHeight−1, ctDepthVer+1 ) | |
| if( x1 < pic_width_in_luma_samples && y1 < pic_height_in_luma_samples ) | |
| coding_tree( x1, y1, log2CbWidth − 1, ctDepthHor + 1, log2CbHeight−1, ctDepthVer+1 ) | (1-3c) |
| } else if( hor_split_flag[ x0 ][ y0 ] ) { | (1-4a) |
| y1 = y0 + ( 1 << ( log2CbSize − 1 ) ) | (1-4b) |
| coding_tree( x0, y0, log2CbWidth, ctDepthHor, log2CbHeight−1, ctDepthVer+1 ) | |
| if( y1 < pic_height_in_luma_samples ) | |
| coding_tree( x0, y1, log2CbWidth, ctDepthHor, log2CbHeight−1, ctDepthVer+1 ) | (1-4c) |
| } else if( ver_split_flag[x0][y0] ) { | (1-5a) |
| x1 = x0 + ( 1 << ( log2CbSize − 1 ) ) | (1-5b) |
| coding_tree( x0, y0, log2CbWidth − 1, ctDepthHor + 1, log2CbHeight, ctDepthVer ) | |
| if( x1 < pic_width_in_luma_samples ) | |
| coding_tree( x1, y0, log2CbWidth − 1, ctDepthHor + 1, log2CbHeight, ctDepthVer ) | (1-5c) |
| } else | |
| coding_unit( x0, y0, log2CbWidth, log2CbHeight) | (1-6) |
| } | |

In Table 1, both hor_split_flag[x0][y0] (as indicated by Note (1-1)) and ver_split_flag[x0][y0] (as indicated by Note (1-2)) are included to signal whether horizontal split and vertical split occur. If both horizontal split and vertical split occur as indicated by Note (1-3a), statements from Note (1-3b) to Note (1-3c) are signaled. If only horizontal split occurs as indicated by Note (1-4a), statements from Note (1-4b) to Note (1-4c) are signaled. If only vertical split occurs as indicated by Note (1-5a), statements from Note (1-5b) to Note (1-5c) are signaled. Otherwise, (i.e., no horizontal split and no vertical split), the whole block is treated as a single coding unit as indicated by Note (1-6).

Furthermore, in the above syntax table, the location (x0,y0) specifies the top-left sample of the current coding block relative to the top-left sample of the current picture. The variable log 2CbWidth and log 2CbHeight are the log 2 of the block width and height respectively. The syntax element hor_split_flag is present only if y0 plus the block height is less than the picture height and block height is larger than the minimum coding block size. The syntax element ver_split_flag is present only if x0 plus the block width is less than the picture width and block width is larger than the minimum coding block size. The semantics of these two flags are as follows:

When hor_split_flag[x0][y0] is not present, the following applies:
If log 2CbHeight is greater than MinCbLog2SizeY, the value of hor_split_flag[x0][y0] is inferred to be equal to 1.
Otherwise (log 2CbHeight is equal to MinCbLog2SizeY), the value of hor_split_flag[x0][y0] is inferred to be equal to 0.

The array CtDepthVer[x][y] specifies the vertical depth for a luma coding block covering the location (x, y). When hor_split_flag[x0][y0] is equal to 0, CtDepthVer[x][y] is inferred to be equal to ctDepthVer for x=x0, . . . , x0+nCbW−1 and y=y0, . . . , y0+nCbH−1, where nCbW=1<<log 2CbWidth and nCbH=1<<log 2CbHeight.

When ver_split_flag[x0][y0] is not present, the following applies:
If log 2CbWidth is greater than MinCbLog2SizeY, the value of ver_split_flag[x0][y0] is inferred to be equal to 1.
Otherwise (log 2CbWidth is equal to MinCbLog2SizeY), the value of ver_split_flag[x0][y0] is inferred to be equal to 0.

The array CtDepthHor[x][y] specifies the horizontal depth for a luma coding block covering the location (x, y). When ver_split_flag[x0][y0] is equal to 0, CtDepthHor[x][y] is inferred to be equal to ctDepthHor for x=x0, . . . , x0+nCbW−1 and y=y0, . . . , y0+nCbH−1.

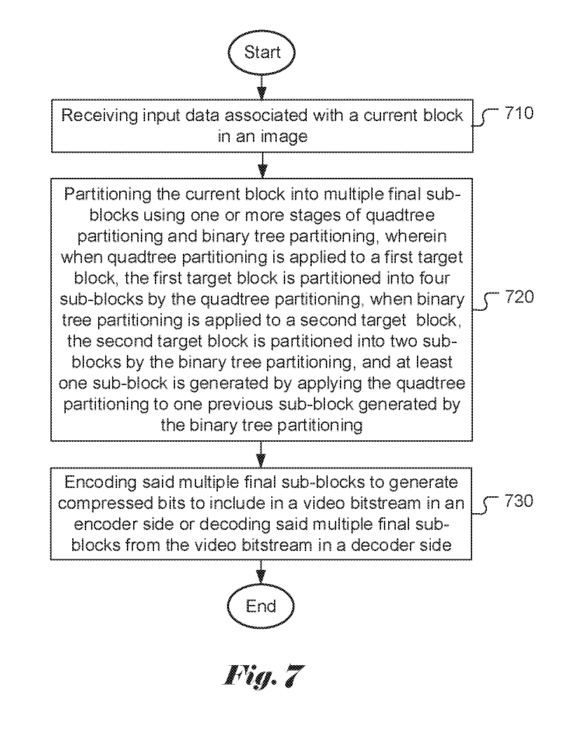

If hor_split_flag and vertical_split_flag are both equal to 0, then the current block is neither split in the horizontal direction nor the vertical direction as shown by partition 610 in FIG. 6. If hor_split_flag is equal to 1 and vertical split flag is equal to 0, then the current block is split in the horizontal direction into 2 sub-blocks (i.e., a top sub-block and a bottom sub-block) as shown by partition 620 in FIG. 6. If hor_split_flag is equal to 0 and vertical split flag is equal to 1, then the current block is split in the vertical direction into 2 sub-blocks (i.e., a left sub-block and a right sub-block) as shown by partition 630 in FIG. 6. If hor_split_flag and vertical_split_flag are both equal to 1, then the current block is split into 4 sub-blocks of equal size using QT as shown by partition 640 in FIG. 6.

Note that the current block is not necessarily a square block. Also, the order of signaling hor_split_flag and ver_split_flag can be changed.

The vertical and horizontal split flags, i.e. ver_split_flag and hor_split_flag may be bypass coded or adaptive binary coded with contexts.

Context Modeling

In one embodiment, a first set of contexts can be used for coding the vertical split flag and a second set of contexts can be used for coding the horizontal split flag. In other words, the vertical split flag and the horizontal split flag use separate sets of contexts. Each set of contexts comprises one or more contexts.

In one embodiment, each set of contexts comprises only one context. In other words, a first context is used for coding the vertical split flag and a second context is used for coding the horizontal split flag.

In another embodiment, a first set of two contexts is used for coding the vertical split flag and a second set of two contexts is used for coding the horizontal split flag. The context is dependent on the corresponding flag of the immediate previous coded block. For example, the context index for coding current hor_split_flag is set equal to the hor_split_flag of the immediate previous coded block; and the context index for coding current ver_split_flag is set equal to the ver_split_flag of the immediate previous coded block.

In still another embodiment, one set of two contexts is used for coding both the vertical split flag and horizontal split flag. In other words, the two flags share the same context set. The context index for coding the current hor_split_flag is set equal to the hor_split_flag of the immediate previous coded block, the context index for coding current ver_split_flag is set equal to the ver_split_flag of the immediate previous coded block.

In still another embodiment, a first set of two contexts is used for coding the vertical split flag and second set of two contexts is used for coding the horizontal split flag. The context for horizontal split flag is dependent on the CtDepthVer of the left neighboring coded block. One context is used for the CtDepthVer value of the left neighboring coded block being larger than the current ctDepthVer, and one context is used for the other case. The context for vertical split flag is dependent on the CtDepthHor of the above neighboring coded block. One context is used for the CtDepthHor value of the above neighboring coded block being larger than the current ctDepthHor, and one context is used for the other case.

In still another embodiment, one set of two contexts is used for coding both the vertical split flag and horizontal split flag. In other words, the two flags share the same context set. The context index for horizontal split flag is dependent on the CtDepthVer of the left neighboring coded block. Context index equal to “0” is used for the CtDepthVer value of the left neighboring coded block being larger than the current CtDepthVer value, and context index equal to “1” is used for the other case. The context index for the vertical split flag is dependent on the CtDepthHor of the above neighboring coded block. Context index equal to “0” is used for the CtDepthHor value of the above neighboring coded block being larger than the current CtDepthHor value, and context index equal to “1” is used for the other case.

In still another embodiment, a first set of three contexts is used for coding the vertical split flag and second set of three contexts is used for coding the horizontal split flag. The context for coding the current hor_split_flag is dependent on the corresponding flags of the top and left neighboring blocks. For example, one context is used for the case that the horizontal split flags (or the vertical split flags) of both the top and left neighboring blocks are 0; one context is used for the case that the horizontal split flags (or the vertical split flags) of both the top and left neighboring blocks are 1; and one context is used for the case that one of the horizontal split flags (or the vertical split flags) of the top and left neighboring blocks is 0 and the other is 1. The context for coding current ver_split_flag is dependent on the corresponding flag of the top and left neighboring blocks. The same approach as described for hor_split_flag can be used for derivation of context for ver_split_flag.

In still another embodiment, one set of three contexts is used for coding the vertical split flag and horizontal split flag. In other words, the two flags share the same context set. The context for coding the current hor_split_flag is dependent on the corresponding flag of the top and left neighboring blocks. Similarly, the context for coding current ver_split_flag is dependent on the corresponding flag of the top and left neighboring blocks. For example, one context is used for the case that the horizontal split flags (or the vertical split flags) of both the top and left neighboring blocks are 0; one context is used for the case that the horizontal split flags (or the vertical split flags) of both the top and left neighboring blocks are 1; and one context is used for the case that one of the horizontal split flags (or the vertical split flags) of the top and left neighboring blocks is 0 and the other is 1.

In still another embodiment, a first set of three contexts is used for coding the vertical split flag and a second set of three contexts is used for coding the horizontal split flag. The context for coding current hor_split_flag/ver_split_flag is dependent on the CtDepthVer/CtDepthHor of the top and left neighboring blocks. For example, one context is used for the case that the CtDepthVer/CtDepthHor values of both the top and left neighbor blocks are larger than the current ctDepthVer/ctDepthHor value; one context is used for the case that the CtDepthVer/CtDepthHor values of both the top and left neighboring blocks are smaller than or equal to current ctDepthVer/ctDepthHor value; one context is used for the case that only one of the CtDepthVer/CtDepthHor values of the top and top neighboring blocks is larger than current ctDepthVer/ctDepthHor. The other can be smaller than or equal to the current ctDepthVer/ctDepthHor value.

In still another embodiment, one set of three contexts is used for coding the vertical split flag and horizontal split flag. In other words, the two flags share the same context set. The context for coding current hor_split_flag/ver_split_flag is dependent on the CtDepthVer/CtDepthHor values of the top and left neighboring blocks. For example, one context is used for the case that the CtDepthVer/CtDepthHor values of both the top and left neighboring blocks are larger than the current ctDepthVer/ctDepthHor value; one context is used for the case that the CtDepthVer/CtDepthHor values of both the top and left neighboring blocks are smaller than or equal to the current ctDepthVer/ctDepthHor value; and one context is used for the case that only one of the CtDepthVer/CtDepthHor values of the top and left neighboring blocks is larger than current ctDepthVer/ctDepthHor value. The other value can be smaller than or equal to the current ctDepthVer/ctDepthHor value.

In the above, hor_split_flag equal to 1 indicates a horizontal split. In this case, the block height is divided by 2, which means that the vertical depth CtDepthVer is added by 1. Similarly, ver_split_flag equal to 1 indicates a vertical split. In this case, the block width is divided by 2, which means that the horizontal depth CtDepthHor is added by 1. Therefore, hor_split_flag corresponds to CtDepthVer and ver_split_flag corresponds to CtDepthHor in the above disclosure. If a previous coded neighboring block is not available, the corresponding flag is set as “0”. When coding the hor_split_flag, it will check the CtDepthVer of its neighboring coded blocks and decide the context index accordingly. Similarly, when coding the ver_split_flag, it will check the CtDepthHor of its neighboring coded blocks and decide the context index accordingly. The contexts may be reset at sequence, picture, slice or coding tree level.

FIG. 7 illustrates a flowchart of an exemplary coding system using flexible quadtree and binary tree partitions, where a quadtree partition is further applied to a previous binary tree partitioned block. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to this method, input data associated with a current block in an image are received in step 710. The current block is partitioned into multiple final sub-blocks using one or more stages of quadtree partitioning and binary tree partitioning in step 720. When quadtree partitioning is applied to a first target block, the first target block is partitioned into four sub-blocks by the quadtree partitioning. When binary tree partitioning is applied to a second target block, the second target block is partitioned into two sub-blocks by the binary tree partitioning. According to this embodiment, at least one sub-block is generated by applying the quadtree partitioning to one previous sub-block generated by the binary tree partitioning. Said multiple final sub-blocks are then encoded to generate compressed bits to include in a video bitstream in an encoder side or said multiple final sub-blocks are decided from the video bitstream in a decoder side in step 730.

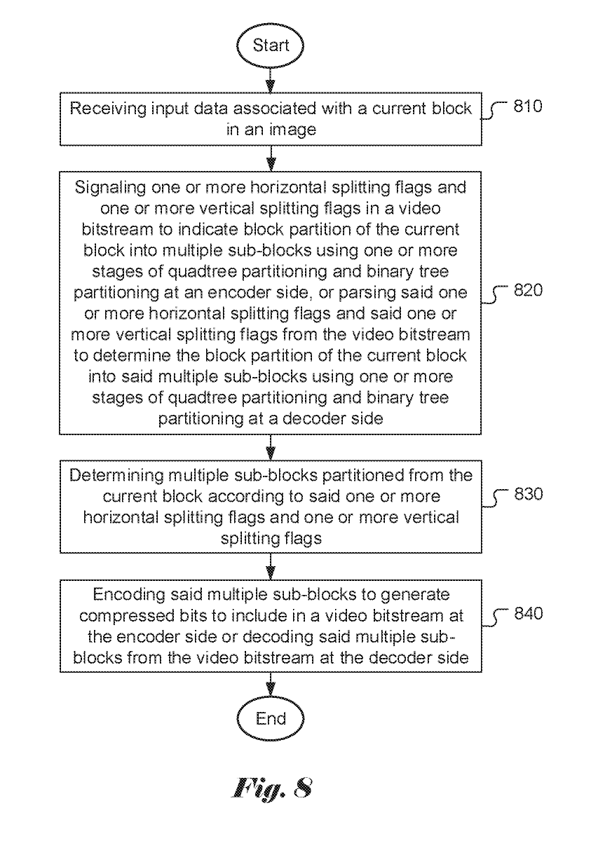

FIG. 8 illustrates a flowchart of another exemplary coding system using block partition, where a horizontal split flag and a vertical split flag are used to signal flexible quadtree and binary tree partitions. According to this method, input data associated with a current block in an image are received in step 810. In step 820, one or more horizontal splitting flags and one or more vertical splitting flags are signaled in a video bitstream to indicate block partition of the current block into multiple sub-blocks using one or more stages of quadtree partitioning and binary tree partitioning at an encoder side, or said one or more horizontal splitting flags and said one or more vertical splitting flags are parsed from the video bitstream to determine the block partition of the current block into said multiple sub-blocks using one or more stages of quadtree partitioning and binary tree partitioning at a decoder side. Multiple sub-blocks partitioned from the current block are determined according to said one or more horizontal splitting flags and one or more vertical splitting flags in step 830. Said multiple sub-blocks are then encoded to generate compressed bits to include in a video bitstream in an encoder side or said multiple final sub-blocks are decoded from the video bitstream in a decoder side in step 830.

The flowcharts shown are intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

In still another embodiment, the above presented methods can also be applied to other flexible block partition variants, as long as a target block can be generated by two or more different partitions.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding, the method comprising:
receiving input data associated with a current block in an image;
partitioning the current block into multiple final sub-blocks using one or more stages of quadtree partitioning and binary tree partitioning, wherein when quadtree partitioning is applied to a first target block, the first target block is partitioned into four sub-blocks by the quadtree partitioning, when binary tree partitioning is applied to a second target block, the second target block is partitioned into two sub-blocks by the binary tree partitioning, and at least one sub-block is generated by applying the quadtree partitioning to one previous sub-block generated by the binary tree partitioning; and
encoding said multiple final sub-blocks to generate compressed bits to include in a video bitstream in an encoder side or decoding said multiple final sub-blocks from the video bitstream in a decoder side.

2. The method of claim 1, wherein the current block corresponds to a coding tree unit (CTU) and each final sub-block corresponds to a coding unit (CU), prediction unit (PU) or transform unit (TU).

3. The method of claim 1, wherein the current block corresponds to a coding tree unit (CTU), each CTU is partitioned using one or more stages of quadtree partitioning into one or more leaf nodes, said one or more leaf nodes are further partitioned using one or more stages of binary tree partitioning into two or more BT-partition sub-blocks, and at least one of said two or more BT-partition sub-blocks is further partitioned by the quadtree partitioning into four sub-blocks.

4. An apparatus of video coding, the apparatus comprising one or more electronic circuits or processors arrange to:
receive input data associated with a current block in an image;
partition the current block into multiple final sub-blocks using one or more stages of quadtree partitioning and binary tree partitioning, wherein when quadtree partitioning is applied to a first target block, the first target block is partitioned into four sub-blocks by the quadtree partitioning, when binary tree partitioning is applied to a second target block, the second target block is partitioned into two sub-blocks by the binary tree partitioning, and at least one sub-block is generated by applying the quadtree partitioning to one previous sub-block generated by the binary tree partitioning; and
encode said multiple final sub-blocks to generate compressed bits to include in a video bitstream in an encoder side or decode said multiple final sub-blocks from the video bitstream in a decoder side.

5. A method of video coding, the method comprising:
receiving input data associated with a current block in an image;
signaling one or more horizontal splitting flags and one or more vertical splitting flags in a video bitstream to indicate block partition of the current block into multiple sub-blocks using one or more stages of quadtree partitioning and binary tree partitioning at an encoder side, or parsing said one or more horizontal splitting flags and said one or more vertical splitting flags from the video bitstream to determine the block partition of the current block into said multiple sub-blocks using one or more stages of quadtree partitioning and binary tree partitioning at a decoder side;
determining multiple sub-blocks partitioned from the current block according to said one or more horizontal splitting flags and one or more vertical splitting flags; and
encoding said multiple sub-blocks to generate compressed bits to include in a video bitstream at the encoder side or decoding said multiple sub-blocks from the video bitstream at the decoder side.

6. The method of claim 5, wherein if one target block is partitioned into four sub-blocks using quadtree partitioning, one horizontal splitting flag and one vertical splitting flag associated with the target block indicate horizontal binary partition and vertical binary partition.

7. The method of claim 5, wherein if one target block is partitioned into one top sub-block and one bottom sub-block using binary tree partitioning, one horizontal splitting flag associated with the target block indicates horizontal binary partition and one vertical splitting flag associated with the target block indicates no vertical binary partition.

8. The method of claim 5, wherein if one target block is partitioned into one left sub-block and one right sub-block using binary tree partitioning, one vertical splitting flag associated with the target block indicates vertical binary partition and one horizontal splitting flag associated with the target block indicates no horizontal binary partition.

9. The method of claim 5, wherein if one target block is not partitioned at all, one horizontal splitting flag and one vertical splitting flag associated with the target block indicate no horizontal binary partition and no vertical binary partition.

10. The method of claim 5, wherein if one horizontal splitting flag associated with a target block is not present in the video bitstream, said one horizontal splitting flag associated with the target block is inferred to have a value indicating horizontal binary partition if height of the target block is greater than a minimum block height; and said one horizontal splitting flag associated with the target block is inferred to have a value indicating no horizontal binary partition if height of the target block is smaller than or equal to the minimum block height.

11. The method of claim 5, wherein if one vertical splitting flag associated with a target block is not present in the video bitstream, said one vertical splitting flag associated with the target block is inferred to have a value indicating vertical binary partition if width of the target block is greater than a minimum block width; and said one vertical splitting flag associated with the target block is inferred to have a value indicating no vertical binary partition if width of the target block is smaller than or equal to the minimum block width.

12. The method of claim 5, wherein said one or more horizontal splitting flags and said one or more vertical splitting flags are bypass coded.

13. The method of claim 5, wherein said one or more horizontal splitting flags and said one or more vertical splitting flags are adaptive binary coded with one or more sets of contexts, and wherein each set of contents comprises at least one context.

14. The method of claim 13, wherein said one or more horizontal splitting flags and said one or more vertical splitting flags share a same set of contexts.

15. The method of claim 13, wherein said one or more horizontal splitting flags and said one or more vertical splitting flags use two separate sets of contexts.

16. The method of claim 13, wherein a first separate set of contexts for said one or more horizontal splitting flags is dependent on a respective horizontal splitting flag of an immediate previous coded block and a second separate set of contexts for said one or more vertical splitting flags is dependent on a respective vertical splitting flag of the immediate previous coded block.

17. The method of claim 13, wherein a first separate set of contexts for said one or more horizontal splitting flags is dependent on respective horizontal splitting flags of an above neighboring block and a left neighboring block, and a second separate set of contexts for said one or more vertical splitting flags is dependent on respective vertical splitting flags of the above neighboring block and the left neighboring block.

18. The method of claim 13, wherein a first separate set of contexts for said one or more horizontal splitting flags is dependent on a vertical depth of a left neighboring block and a second separate set of contexts for said one or more vertical splitting flags is dependent on a horizontal depth of the left neighboring block.

19. The method of claim 13, wherein a first separate set of contexts for said one or more horizontal splitting flags is dependent on vertical depths of an above neighboring block and a left neighboring block, and a second separate set of contexts for said one or more vertical splitting flags is dependent on horizontal depths of the above neighboring block and the left neighboring block.

20. An apparatus of video coding, the apparatus comprising one or more electronic circuits or processors arrange to:
receive input data associated with a current block in an image;
signal one or more horizontal splitting flags and one or more vertical splitting flags in a video bitstream to indicate block partition of the current block into multiple sub-blocks using one or more stages of quadtree partitioning and binary tree partitioning at an encoder side, or parse said one or more horizontal splitting flags and said one or more vertical splitting flags from the video bitstream to determine the block partition of the current block into said multiple sub-blocks using one or more stages of quadtree partitioning and binary tree partitioning at a decoder side;
determine multiple sub-blocks partitioned from the current block according to said one or more horizontal splitting flags and one or more vertical splitting flags; and
encode said multiple sub-blocks to generate compressed bits to include in a video bitstream or decode said multiple sub-blocks from the video bitstream.
